(19) United States
(12) Patent Application Publication
(10) Pub. No.: US 2002/0074758 A1
(43) Pub. Date: Jun. 20, 2002

(54) Suspension system for a vehicle

(76) Inventor: Oscar Frey, Listowel (CA)

Correspondence Address: PEARNE & GORDON LLP, 526 SUPERIOR AVENUE EAST, SUITE 1200, CLEVELAND, OH, 44114-1484, US

(21) Appl. No.: 10/023,550

(22) Filed: Dec. 17, 2001

(30) Foreign Application Priority Data
Dec. 20, 2000 (CA) 2,329,163

(51) Int. Cl. B60G 1/00

(52) U.S. Cl. 280/124.16; 280/124.157

(57) ABSTRACT

Disclosed is a suspension system for equalizing the load on a vehicle, preferably a farm wagon. The system comprises four double acting hydraulic cylinders at each of the four corners of a farm wagon which are plumbed in a closed loop circuit. Fluid displaces between the four cylinders during use in order to maintain equilibrium within the system. The displacing fluid results in movement of each respective corner and wheel with respect to the ground.

### FIELD

The invention relates generally to vehicles, and more particularly to a suspension system for a vehicle.

### BACKGROUND

It is known that vehicles generally require some form of suspension means and many designs of such suspension means have been developed over the years. In particular, farm wagons conventionally require a suspension means to allow for the equalization of the loads on the wheels of the wagon during use. As a wagon traverses the ground, it will pass over rough, uneven terrain. When a wheel encounters any unevenness in the ground surface, it is forced in the direction of the contours causing the load on the wagon to become unbalanced. The wagon frame, then experiences stress and may twist as it travels over the rough terrain. For example, if one wheel passes over a bump, such as a rock, the corner of the frame corresponding to the wheel will be pushed upwards. As a result, the load on the various wheels will differ, and the frame may twist. Similarly, if one wheel encounters a rut, the load on the wheel will decrease and the frame may twist.

Conventional suspension systems comprise generally complicated hydraulic circuits, utilizing fluid regulators, intermediate accumulators and sump pump means. The addition of such circuits to farm wagons increases the cost associated with their operation and makes them overly complicated to operate. Also, conventional systems have not allowed total equalization between all four corners across the front and rear members of the frame with respect to one another.

Thus, there is a need for a suspension system to equalize the load on the wheels as the wagon passes over uneven terrain. It would be beneficial if the suspension system allowed for all corners of the frame to be equalized in relation to one another, as well. There is also a need to accomplish this with a suspension system that is simple and cost effective.

### SUMMARY

A suspension system that alleviates the problems associated with conventional suspension systems is disclosed.

According to an embodiment of the invention, there is provided a suspension system for a vehicle comprising a rigid frame having four corners with at least one wheel mounted to each corner of the frame; the suspension system comprising: at least three hydraulic cylinders, each cylinder adapted to be operatively connected between an associated corner of the frame and a respective one of the wheels; and a plurality of hydraulic lines adapted to be connected so as place the cylinders in communication with one another in a closed loop hydraulic circuit, wherein during operation with said system installed on the vehicle, the closed loop circuit maintains equilibrium between said at least three cylinders.

According to an embodiment of the invention, there is provided a vehicle comprising a rigid frame having at least four spaced apart wheels mounted thereon to rollingly support the frame above the ground, said vehicle having a suspension system including: at least three spaced apart hydraulic cylinders, each cylinder adapted to be operatively connected between an associated corner of the frame and a respective one of the wheels; and a plurality of hydraulic lines connecting said cylinders in communication with one another to form a closed loop hydraulic circuit such that during operation with said system installed on the vehicle, the closed loop circuit maintains equilibrium between said at least three cylinders allowing load equalization as between the vehicle wheels.

The following advantages of embodiments of the invention may be realized:

The loads on the vehicle wheels are equalized as the vehicle travels over uneven terrain;

The equalized loads on the vehicle wheels result in greater stability for the vehicle; and

The suspension system is generally uncomplicated and does not require the use of extraneous parts.

The load between all four corners of the frame are equalized interdependently.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

Embodiments of the invention will be described with reference to the accompanying drawings, wherein:

FIG. 1 illustrates a farm wagon typical in the art with a hydraulic suspension system according to an embodiment of the invention mounted thereto;

FIG. 2 illustrates a schematic of the wagon of FIG. 1;

FIG. 3 illustrates an embodiment of the hydraulic circuit used in FIGS. 1 and 2;

FIG. 4 illustrates the circuit of FIG. 3 during operation with the rear left wheel in a hole; and

FIG. 5 illustrates an alternative embodiment of the circuit of FIG. 2.

Similar references are used in different figures to denote similar components.

### DETAILED DESCRIPTION

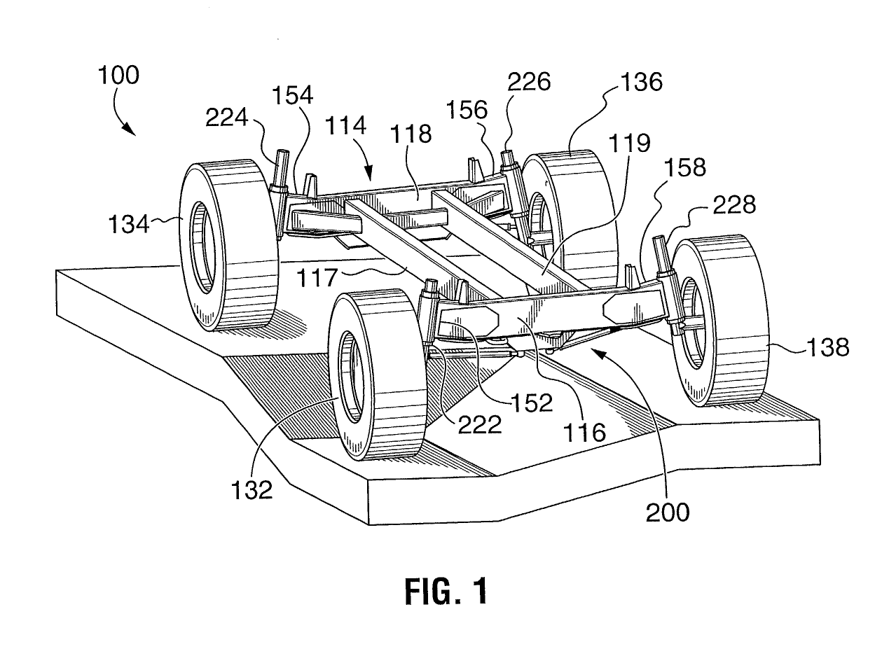

Referring to FIG. 1, there is illustrated a farm wagon 100 to which a suspension system 200 can be mounted. While the suspension system 200 can be used on any wheeled vehicle, preferably it is used on a farm wagon 100 of the type illustrated. The wagon 100 includes a rigid frame 114 comprising of four corners 152 (rear left), 154 (front left), 156 (front right) and 158 (rear right) across transversely spaced apart front rigid frame member 116 and rear rigid frame member 118 and left rigid frame member 117 and right rigid frame member 119. The rigid frame 114 may have mounted to the top a cart or other such structure (not shown). Mounted to each of the four corners is at least one wheel 132, 134, 136 and 138. Additional wheels may be mounted as required for safe operation of the wagon.

Each wheel 132, 134, 136 and 138 is mounted to the frame 114 in a conventional manner, such that the wheel rotates to allow the frame to traverse the ground when hitched to a prime mover, such as a tractor (not shown). As the wagon travels over the ground, any wheel may encounter an obstacle, such as a bump or a rut. The wheel will then move relative to the ground obstacle, causing a shift in the load experienced by various wheels supporting the wagon.

The wagon 100 has mounted to it a suspension system 200 according to an embodiment of the invention. Hydraulic actuators 222, 224, 226 and 228 are fixed to support each of the four frame corners 152, 154, 156, and 158 respectively. The actuators may also be referred to as rear left, front left, front right, and rear right cylinders. Additional cylinders may be added as well. Each additional wheel may have its own additional corresponding cylinder. Each actuator comprises a cylinder which is preferably a double acting hydraulic cylinder comprising a piston and rod assembly 262, 264, 266 and 268 dividing each cylinder into a lower part and an upper part. Preferably, each wheel is rotatably mounted to the piston's rod as well. In a preferred embodiment, the cylinders are substantially vertically oriented between the frame and corresponding wheel.

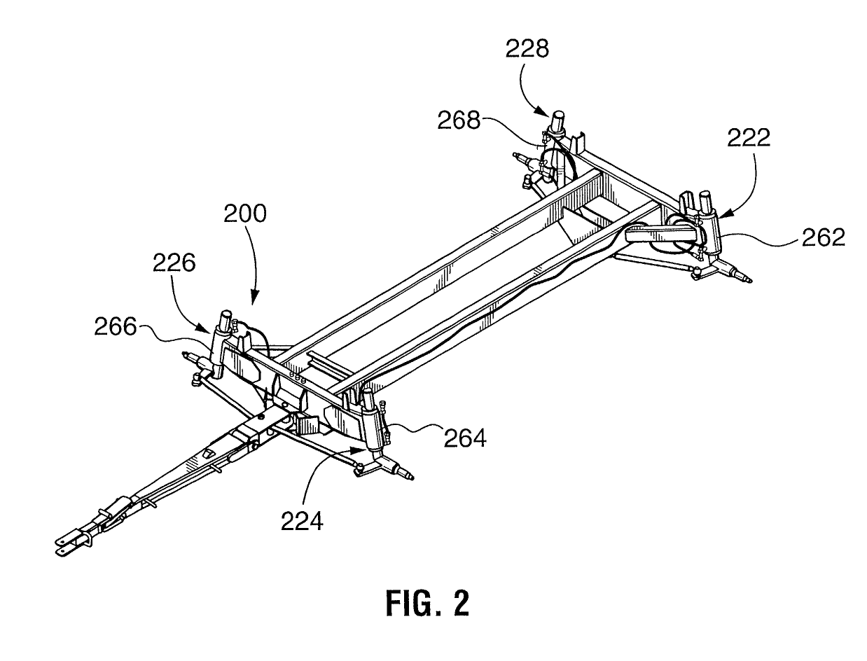

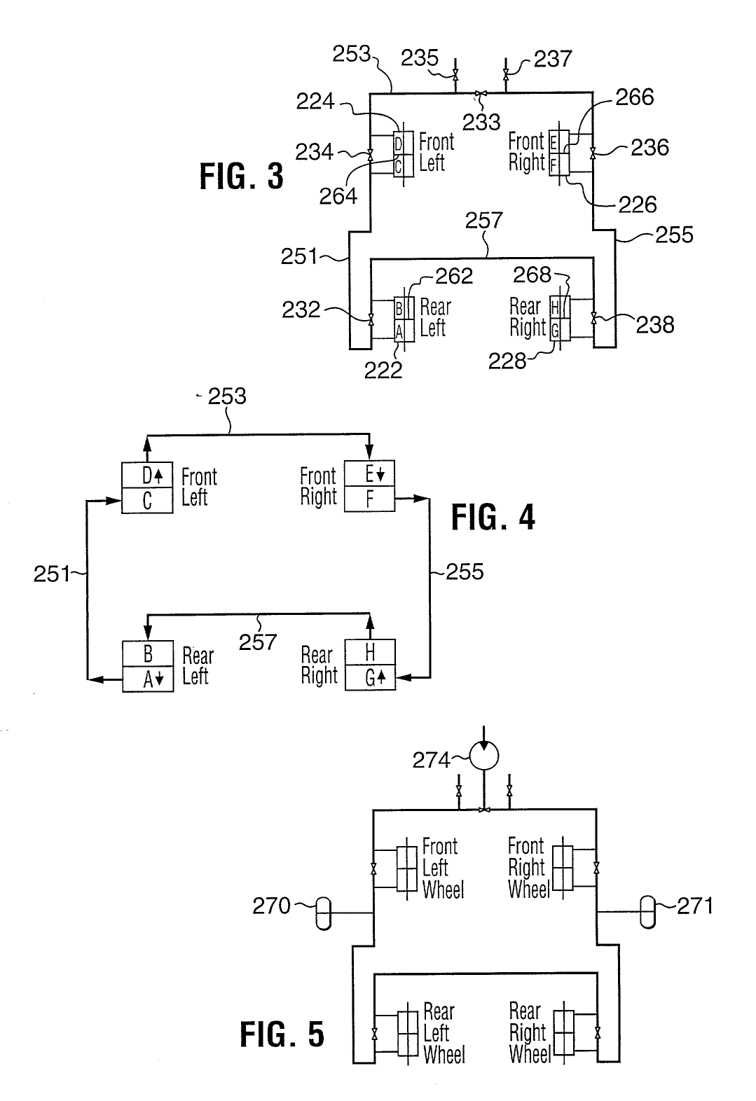

Referring to FIGS. 2 and 3, the hydraulic circuit is illustrated. Each actuator is in either direct or indirect communication with one another. It is seen that where there is direct communication between two cylinders, they are in communication via the same cylinder part. That is, where there is direct communication, a first lower cylinder part communicates with a second lower cylinder part. It is also seen that where there is direct communication it is in both front to left and rear to front directions. While it is shown that the upper parts of the two rear and two front cylinders via hydraulic lines 257 and 253 respectively are in direct communication, while the lower parts of the two left and two right cylinders via hydraulic lines 251 and 255 respectively are in direct communication, the circuit could be reversed wherein the lower parts of the two rear and two front cylinders are in direct communication while the upper parts of the two left and the two right cylinders are in direct communication.

Preferably, prior to operation, fluid is pumped into the circuit filling the lower and upper parts of each cylinder with fluid. This is accomplished by opening valves 232, 233, 234, 235, 236, 237 and 238. During operation, after the lower part and upper part of each cylinder is filled with fluid, the system is closed by closing valves 232, 233, 234, 235, 236, 237 and 238. That is, no further fluid is added nor removed from the circuit. Thus, the four cylinders together with the associated hydraulic lines form a closed loop hydraulic circuit.

Preferably, the hydraulic circuit uses hydraulic oil as the fluid. It is known that in a conventional master-slave circuit, the amount of oil within the circuit does not change, only the amount in each cylinder can change. Therefore, if the piston from one cylinder displaces within the cylinder, oil is forced out of one part and enters the circuit. The amount of oil forced out is proportional to the amount of movement of the piston, and the oil is forced into the remaining cylinder of the circuit, causing its respective piston to move proportionally in order to maintain equilibrium within the circuit.

Referring to FIG. 1, during operation, the wagon 100 may encounter obstacles, including ruts or bumps, over the ground. FIG. 1 illustrates the wagon 100 as wheel 132 encounters a rut or hole. The wheel is forced down relative to the ground surface. This results in an unevenness in load experienced amongst each of the four corners of the frame. In order to balance the load between the four corners, the excess load being carried by the corner corresponding to the wheel in the hole must be equalized amongst the other corners. When the wheel falls into the hole or rut, that wheel lowers with respect to the ground. This in turn adds force to the piston in the corresponding cylinder causing the piston to displace downwards into the lower part of the cylinder. The force from the piston results in fluid being forced out of the lower part of the cylinder into the closed loop circuit.

Referring to FIG. 4, the action of the hydraulic circuit is illustrated in the case where the rear left wheel encounters a hole. The fluid in the closed loop circuit is communicated to one or more of the remaining cylinders. Following the pattern of the circuit, the fluid is forced into the cylinders causing the corresponding pistons to be displaced. This displacement causes one or more corners to be lowered. Since the amount of fluid in the circuit remains constant, the net result is that a lowering of one or more corners results in a rising of the corner corresponding to the wheel in the rut, and thus a self-levelling of the frame and equalization of the load between the four corners.

For example if the rear left tire fell into a rut, some fluid in the corresponding rear left cylinder would be forced from part A directly into part C of the front left cylinder forcing the piston to displace and forced out of part D into part E of the front right cylinder. This forces the piston to displace and force fluid out of part F into part G of the rear right cylinder. This, finally, displaces the piston forcing fluid out of part H into part B, finishing off the closed loop circuit and equalizing the loads.

Similarly, if a wheel encounters a bump, that corner of the frame rises with respect to the ground. The wheel is raised with respect to the ground. This in turn adds force to the piston in the corresponding cylinder causing the piston to displace. The force from the piston results in fluid being forced out of the cylinder into the closed loop circuit.

The fluid in the closed loop circuit is communicated to one or more of the remaining cylinders. Following the pattern of the circuit, the fluid is forced into the cylinders causing the corresponding pistons to be displaced upwards. This displacement causes one or more corners to rise. Since the amount of fluid in the circuit remains constant, the net result is that a rise in one or more corners results in a lowering of the corner corresponding to the wheel on the bump, and thus a self-levelling of the frame and equalization of the load between the four corners.

In a preferred embodiment, the full stroke of the piston is six inches and on level ground, the piston is located in the centre of the stroke. However, a stroke of any length can be used. The piston can be located at any position along the stroke on even ground as well. As well, the pressure within the circuit is preferably maintained at about 100 to 200 psi.

As seen in FIG. 5, in one embodiment, the circuit may include an accumulator 270 and 271 on each of the left side and right side acting as a shock absorber. In another embodiment also seen in FIG. 5, the hydraulic system may be charged with a hydraulic system including a hydraulic pump 274 in use on a tractor.

With the use of the suspension system, the wagon remains level and stabilized as it traverse the uneven ground. The uneven loads on the wheels and corresponding corners of the frame are balanced by the appropriate displacement of the fluid. By maintaining the closed loop circuit in equilibrium, the suspension system allows equalization of load on the frame between all four cylinders. By not including the use of intermediate parts such as accumulators and valves, the circuit remains simple to operate and cost effective to maintain.

While the invention has been described according to what are presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A suspension system for a vehicle comprising a rigid frame having four corners with at least one wheel mounted to each corner of the frame; the suspension system comprising:
at least three hydraulic cylinders, each cylinder adapted to be operatively connected between an associated corner of the frame and a respective one of the wheels; and
a plurality of hydraulic lines adapted to be connected so as place the cylinders in communication with one another in a closed loop hydraulic circuit, wherein during operation with said system installed on the vehicle, the closed loop circuit maintains equilibrium between said at least three cylinders.

2. The suspension system of claim 1, wherein each cylinder is a double acting cylinder comprising a piston, the piston dividing the cylinder into an upper part and a lower part, the piston being moveable within the cylinder.

3. The suspension system of claim 2 wherein each cylinder is adapted to be positioned substantially vertically between the frame and each respective wheel.

4. The suspension system of claim 2 comprising four cylinders, wherein each cylinder and its associated hydraulic lines are capable of providing direct communication with at least two of the remaining cylinders.

5. The suspension system of claim 4 wherein the four cylinders comprise a left rear, a left front, a right rear and a right front cylinder and wherein the two front cylinders, the two rear cylinders, the two left cylinders and the two right cylinders via the associated hydraulic lines when in use are in direct communication with one another such that during operation, fluid in the hydraulic circuit displaces between the four cylinders to maintain equilibrium.

6. The suspension system of claim 5 wherein each wheel is adapted to be rotatably mounted to the piston of its respective cylinder such that each wheel moves with respect to the ground according to the fluid displacement in each cylinder.

7. The suspension system of claim 6 wherein each cylinder is adapted to be positioned substantially vertically between the frame and each respective wheel.

8. The suspension system of claim 1 further adapted to comprise open/closed hydraulic valves that, in an open position allow fluid to enter and exit the circuit and in a closed position, restrict fluid from entering and exiting the circuit.

9. The suspension system of claim 8, further adapted to comprise an accumulator on either side of the system.

10. The suspension system of claim 9, further comprising a pump for pumping fluid into the system.

11. A vehicle comprising a rigid frame having at least four spaced apart wheels mounted thereon to rollingly support the frame above the ground, said vehicle having a suspension system including:
at least three spaced apart hydraulic cylinders, each cylinder adapted to be operatively connected between an associated corner of the frame and a respective one of the wheels; and a plurality of hydraulic lines connecting said cylinders in communication with one another to form a closed loop hydraulic circuit such that during operation with said system installed on the vehicle, the closed loop circuit maintains equilibrium between said at least three cylinders allowing load equalization as between the vehicle wheels.

12. The vehicle of claim 11, wherein the wheels are associated to a respective one of said corners of the frame.

13. The vehicle of claim 12, wherein each cylinder in the system is a double acting cylinder comprising a piston, the piston dividing the cylinder into an upper part and a lower part, the piston being moveable within the cylinder.

14. The vehicle of claim 13 wherein each cylinder is positioned substantially vertically between the frame and each respective wheel.

15. The vehicle of claim 13 comprising four cylinders, wherein each cylinder and its associated hydraulic lines are capable of providing direct communication with at least two of the remaining cylinders.

16. The vehicle of claim 15 wherein the four cylinders comprise a left rear, a left front, a right rear and a right front cylinder and wherein the two front cylinders, the two rear cylinders, the two left cylinders and the two right cylinders via the associated hydraulic lines when in use are in direct communication with one another such that during operation, fluid in the hydraulic circuit displaces between the four cylinders to maintain equilibrium.

17. The vehicle of claim 16 wherein each wheel is rotatably mounted to the piston of its respective cylinder such that each wheel moves with respect to the ground according to the fluid displacement in each cylinder.

18. The vehicle of claim 17 wherein each cylinder is positioned substantially vertically between the frame and each respective wheel.

19. The vehicle of claim 12 further comprising open/closed hydraulic valves that, in an open position allow fluid to enter and exit the circuit and in a closed position, restrict fluid from entering and exiting the circuit.

20. The vehicle of claim 19, further comprising an accumulator on either side of the system.

21. The vehicle of claim 20, further comprising a pump for pumping fluid into the system.

22. The vehicle of claim 21, wherein the wheels are associated to a respective one of said corners of the frame.

23. A suspension system for a vehicle comprising a rigid frame having three corners with at least one wheel mounted to each corner of the frame; the suspension system comprising:
at least three hydraulic cylinders, each cylinder adapted to be operatively connected between an associated corner of the frame and a respective one of the wheels; and
a plurality of hydraulic lines adapted to be connected so as place the cylinders in communication with one another in a closed loop hydraulic circuit, wherein during operation with said system installed on the vehicle, the closed loop circuit maintains equilibrium between said at least three cylinders.
